(19) United States
(12) Patent Application Publication
(10) Pub. No.: US 2026/0334392 A1
(43) Pub. Date: Oct. 29, 2026

(54) PRECISION IRRIGATION SYSTEM UTILIZING REAL-TIME AND PREDICTIVE DATA

(71) Applicant: Lumo, Inc., Santa Rosa, CA (US)

(72) Inventor: Henry M. Halimi, Los Angeles, CA (US)

(73) Assignee: Lumo, Inc., Santa Rosa, CA (US)

(21) Appl. No.: 19/654,909

(22) Filed: Apr. 22, 2026

Related U.S. Application Data
(60) Provisional application No. 63/794,247, filed on Apr. 24, 2025.

(51) Int. Cl. A01G 25/16

(52) U.S. Cl. CPC A01G 25/167

(57) ABSTRACT

An irrigation system and method are provided for controlling water delivery across an agricultural field divided into multiple independent zones. Each zone includes at least one soil moisture sensor configured to measure moisture at multiple depths within a plant root zone and a controllable valve connected to a distribution manifold. Local controllers receive real-time sensor data and environmental inputs, determine current moisture conditions, and generate predicted moisture levels using learned parameters that characterize soil moisture propagation and decay. Irrigation is initiated when predicted moisture falls below a defined threshold and is terminated based on a projected post-irrigation moisture level, allowing shutoff prior to reaching the desired condition due to continued moisture movement in the soil. The system supports autonomous operation, optional wireless or wired communication, and zone-specific optimization, resulting in improved water efficiency and precise root-zone moisture management.

### CROSS-REFERENCE TO RELATED APPLICATIONS

This non-provisional application claims priority to provisional application 63/794,247 filed on Apr. 24, 2025, the contents of which are fully incorporated herein with this reference.

### DESCRIPTION

### Field of the Invention

The present invention generally relates to water flow control for agriculture. More particularly, the present invention relates to a precision irrigation system for agriculture that delivers the precise amount of irrigation needed based on a multitude of factors.

### Background of the Invention

Conventional irrigation systems employed in agricultural settings typically rely on predetermined schedules or zone-based timing strategies that are not responsive to real-time soil conditions. These systems often apply water uniformly across large areas without regard to localized variations in soil composition, moisture retention characteristics, plant needs, or environmental conditions. As a result, such approaches frequently lead to inefficient water usage, including over-irrigation in some areas and under-irrigation in others, thereby negatively impacting both resource utilization and crop yield.

In an effort to improve irrigation efficiency, certain existing systems incorporate soil moisture sensors and environmental monitoring devices. However, these systems generally rely on simplistic threshold-based control logic, wherein irrigation is initiated or terminated based solely on instantaneous sensor readings. Such approaches fail to account for the dynamic behavior of water within soil, including delayed moisture propagation, vertical percolation, and time-dependent absorption and evaporation processes. Consequently, these systems may still apply excess water or fail to deliver sufficient moisture to critical root-zone depths.

Additionally, many modern irrigation solutions depend on centralized or cloud-based processing architectures to analyze sensor data and generate irrigation schedules. While such systems may provide enhanced computational capabilities, they are often limited by communication reliability, latency, and dependency on external infrastructure. In agricultural environments, where connectivity may be intermittent or unavailable, reliance on cloud-based control can result in delayed or suboptimal irrigation decisions. Furthermore, centralized approaches may not effectively address localized variability across different regions of a field.

Another limitation of existing irrigation technologies is the lack of granular, zone-specific control. Although some systems divide fields into multiple irrigation zones, they often lack the ability to independently optimize each zone based on detailed, depth-specific soil conditions and learned behavior over time. Variations in soil type, terrain, drainage characteristics, and plant growth stages can significantly affect moisture dynamics, yet conventional systems are generally unable to adapt to such variability in a precise and continuous manner.

Moreover, existing systems typically do not incorporate predictive modeling of soil moisture behavior. Irrigation decisions are commonly based on current measurements rather than anticipated future conditions. This reactive approach fails to consider that moisture introduced during irrigation may continue to propagate through the soil after water application has ceased, leading to oversaturation if not properly accounted for. The absence of predictive control mechanisms limits the efficiency and precision of conventional irrigation practices.

Accordingly, there exists a need for an improved irrigation system that can operate autonomously at a localized level, utilize real-time and multi-depth soil moisture data, and incorporate predictive modeling of moisture propagation and decay. There is further a need for such a system to provide independent, zone-based control capable of adapting to changing environmental conditions and soil characteristics without reliance on continuous external connectivity. The present invention addresses these and other shortcomings of existing irrigation technologies, as will be described in greater detail below.

### SUMMARY OF THE INVENTION

The present invention relates to an interactive precision irrigation system with real-time root-zone moisture feedback and autonomous valve control. In the agricultural industry, irrigation scheduling practices—specifically the logic governing volume, intervals, and duration—have not kept pace with other modern data-driven industrial processes. This lag is due in part to the traditional nature of agriculture and, more significantly, the lack of economical and practical systems capable of leveraging available sensor technologies. While some farmers attempt to use fragmented data from sources such as soil moisture sensors and weather stations, the complexity of integrating historical data to predict future conditions results in suboptimal and inconsistent irrigation outcomes. The core objective of this invention is to deliver and maintain precise moisture levels at specific points within a plant's root system while minimizing overall water usage.

To achieve this objective, the invention introduces a practical and economical smart irrigation valve system that utilizes real-time data and feedback-based control mechanisms to precisely regulate both the amount and timing of water delivered during each irrigation event. Because irrigation conditions vary due to numerous factors—including soil composition, moisture retention characteristics, percolation rates, ambient temperature and humidity, pre-irrigation ground conditions, and plant growth cycles—static scheduling models are inherently inadequate. Accordingly, this system employs real-time electronic control combined with advanced data techniques, including machine learning and data analytics, to dynamically adapt irrigation behavior.

At the core of the system is a “smart valve,” defined as an integrated unit consisting of a valve, controller, and supporting components. The controller includes an onboard processing unit and data storage capability, enabling it to autonomously control valve operation without dependence on cloud connectivity, although optional cloud integration may be supported. The system is designed to accept direct input from third-party sensors and may operate on battery power sustained through natural energy sources. This decentralized architecture addresses the limitations of prior cloud-based irrigation systems, particularly in environments with unreliable communication infrastructure.

The system operates through both short-term and long-term processes. In the short term, it continuously optimizes irrigation events using real-time sensor data to maintain desired moisture levels at specific root-zone depths, in accordance with user-defined strategies. These strategies may specify target moisture levels, tolerances, and depth parameters for different planting zones. The system integrates inputs from soil moisture sensors at multiple depths, as well as environmental sensors measuring temperature and humidity, while also accounting for operational constraints such as limited water availability during certain times of day. In the long term, the system aggregates historical irrigation data and correlates it with crop yield and quality outcomes, enabling refinement of irrigation strategies across growing cycles.

A key feature of the invention is its adaptive learning capability. Upon initial deployment, the system undergoes a “learn period” during which it collects and analyzes data to characterize soil behavior. This is necessary because soil properties and environmental interactions vary widely and cannot be accurately modeled using purely theoretical approaches. During this period, the system gathers data from multiple sensor inputs, including soil moisture readings at various depths and environmental conditions, as well as external data such as weather reports. The collected data is continuously evaluated to establish reliable trends and parameters, which are stored locally and used to inform irrigation algorithms. Over time, the system updates these parameters to account for evolving conditions such as soil composition changes and root development.

Unlike conventional irrigation systems that rely on fixed schedules, this invention implements an on-demand irrigation model. The system periodically monitors root-zone moisture levels at frequencies determined by learned parameters. When projected moisture levels approach user-defined critical thresholds, the system notifies the user in advance. Depending on user preferences, irrigation may either be initiated manually or triggered automatically. During irrigation, the system continues to monitor soil conditions and terminates watering when it predicts that the desired moisture levels will be achieved, even if those levels are reached after irrigation ceases. This predictive control mechanism ensures efficient water use while maintaining optimal plant conditions.

The system also incorporates resource optimization features, taking into account factors such as water availability, energy costs, and environmental conditions. For example, if irrigation is powered by electrically driven pumps, the system can schedule operations during periods of lower electricity rates. It can also adapt to restricted water availability windows, respond to anticipated extreme weather conditions, and batch irrigation across multiple zones to reduce operational costs. These capabilities demonstrate the system's versatility and its ability to integrate both agronomic and economic considerations into irrigation management.

Beyond real-time control, the invention provides significant long-term value through the creation of a comprehensive data repository. This data lake enables analysis of irrigation strategies in relation to crop performance metrics, such as yield, appearance, and quality. Users are encouraged to experiment with different irrigation approaches across comparable planting zones and evaluate outcomes using crop-specific attributes—for example, sugar content and color in grapes or size and texture in other produce. The system's analytical algorithms identify correlations between irrigation practices and crop outcomes, enabling continuous improvement of cultivation strategies. Additional non-irrigation data, such as fertilizer usage and cultivation practices, may also be incorporated to enhance analytical accuracy. Over multiple growing seasons, the system can account for environmental variability and provide increasingly refined recommendations.

Furthermore, the system's ability to generate precise, long-term datasets positions it as a valuable research tool. Its deployment across farms enables controlled experimentation and comparative analysis of irrigation strategies under real-world conditions, effectively transforming agricultural sites into research environments capable of advancing agronomic knowledge.

In summary, the invention is an interactive irrigation system designed to deliver water with high spatial and temporal precision at the plant root-zone level. Each irrigation node integrates a moisture sensor and a smart valve controlled by a local processor capable of autonomous decision-making. The system operates in both real-time control and learned scheduling modes, adapting to environmental conditions without reliance on cloud infrastructure. Its architecture supports decentralized operation, optional sensor integration, and energy-efficient design using solar or battery power. Through continuous learning, predictive analytics, and resource-aware optimization, the system provides a scalable and adaptable solution for modern precision agriculture.

An exemplary method for controlling irrigation of an agricultural field is disclosed where the method comprises: dividing the agricultural field into a plurality of irrigation zones; providing, for each irrigation zone, at least one soil moisture sensor configured to measure moisture at a multitude of depths within a root zone of plants in the respective irrigation zone; providing, for each irrigation zone, a corresponding irrigation control unit comprising a controllable valve and a local controller operatively coupled to the at least one soil moisture sensor; receiving, at each local controller, real-time sensor data including at least soil moisture measurements and one or more environmental parameters; determining, for each irrigation zone independently, a current moisture condition of the root zone based on the real-time sensor data; generating, by the local controller for each irrigation zone, a predicted moisture level at a target depth based on (i) the current moisture condition and (ii) one or more learned parameters representing moisture propagation and decay characteristics of soil within the respective irrigation zone; initiating an irrigation event for a selected irrigation zone by actuating the corresponding controllable valve when the predicted moisture level is below a predefined threshold; monitoring, during the irrigation event, updated soil moisture measurements from the at least one soil moisture sensor; determining, by the local controller, a projected post-irrigation moisture level at the target depth based on the updated soil moisture measurements and the learned parameters; and terminating the irrigation event for the selected irrigation zone by closing the controllable valve when the projected post-irrigation moisture level is expected to satisfy a desired moisture condition; wherein each irrigation zone is controlled independently wherein irrigation timing and volume are optimized on a per-zone basis according to zone-specific soil characteristics, environmental conditions, and learned moisture behavior.

In other exemplary embodiments, the at least one soil moisture sensor may comprise a plurality of sensors positioned at different depths within the root zone. The learned parameters may include a rate of moisture propagation between the different depths. The learned parameters may further include moisture decay rates following an irrigation event. The method may include an initial learning period during which the local controller collects sensor data to derive the learned parameters. The learning period may include evaluating sufficiency of collected data prior to using the learned parameters for irrigation control. The environmental parameters may include at least one of ambient temperature, humidity, or weather forecast data. Initiating the irrigation event may further comprise automatically initiating irrigation without user intervention. The method may further comprise generating a notification to a user prior to initiating the irrigation event when the predicted moisture level is expected to fall below the predefined threshold. Terminating the irrigation event may occur prior to the target depth reaching the desired moisture condition based on the projected post-irrigation moisture level. Each irrigation control unit may operate independently without reliance on cloud-based processing. The local controllers may communicate with one another in a network to coordinate irrigation across the plurality of irrigation zones. The method may comprise adjusting irrigation timing based on availability of water supply. The method may comprise adjusting irrigation timing based on energy cost associated with operating irrigation equipment. The method may comprise batching irrigation across multiple zones based on predicted future moisture requirements. The learned parameters may be continuously updated over time to account for changes in soil composition or plant growth. The method may comprise storing irrigation data and correlating the irrigation data with crop yield or quality metrics. The method may comprise modifying irrigation strategies based on the correlation between irrigation data and crop yield or quality metrics.

An exemplary irrigation system for an agricultural field divided into a plurality of irrigation zones is disclosed, the system comprising: a plurality of soil moisture sensors, each associated with a respective irrigation zone and configured to measure soil moisture at a multitude of depths within a root zone; a plurality of irrigation control units, each associated with a respective irrigation zone and comprising: a controllable valve configured to regulate water delivery to the respective irrigation zone; and a local controller operatively coupled to the soil moisture sensors; wherein each local controller is configured to: receive real-time sensor data including soil moisture measurements and environmental parameters; determine a current moisture condition of the root zone for the respective irrigation zone; generate a predicted moisture level at a target depth based on the current moisture condition and learned parameters representing moisture propagation and decay characteristics; actuate the controllable valve to initiate irrigation when the predicted moisture level is below a predefined threshold; monitor updated soil moisture measurements during irrigation; and terminate irrigation based on a projected post-irrigation moisture level such that a desired moisture condition is achieved at the target depth; wherein each irrigation control unit operates independently to optimize irrigation timing and volume for its respective irrigation zone.

In other exemplary embodiments, each irrigation control unit may include onboard data storage configured to store learned parameters. The soil moisture sensors may be positioned at multiple depths within the root zone. Each local controller may include a processor configured to execute a learning algorithm to derive the learned parameters. The irrigation control units may be powered by battery systems supplemented by renewable energy sources. The irrigation control units may be configured to operate without continuous network connectivity. The system may comprise a user interface configured to allow a user to define desired moisture conditions for each irrigation zone. The local controllers may be configured to incorporate weather forecast data into irrigation decisions. The system may be configured to aggregate irrigation and crop data to generate optimized irrigation strategies for future growing cycles.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a flow chart of an exemplary embodiment of the present invention; and

FIG. 2 is a schematic representation of an exemplary embodiment of the present invention.

### DETAILED DESCRIPTION OF THE PREFERRED EMBODIMENTS

The present invention relates to systems and methods for controlling irrigation of an agricultural field through distributed, zone-based, sensor-driven control units that utilize real-time data and predictive modeling to optimize water delivery at the plant root-zone level. The agricultural field is divided into a plurality of irrigation zones, each of which may correspond to a defined geographic area, crop grouping, soil type, elevation profile, or other agronomic distinction. Each irrigation zone is independently monitored and controlled to allow localized optimization of irrigation conditions, thereby improving water efficiency and crop performance relative to conventional centralized or uniform irrigation approaches.

Within each irrigation zone, at least one soil moisture sensor is deployed, and in preferred embodiments, a plurality of soil moisture sensors are positioned at different depths within the root zone of the plants. These sensors are configured to generate measurements indicative of moisture content at discrete vertical levels below the soil surface, thereby enabling characterization of moisture distribution throughout the root zone. Furthermore, each sensor can measure the soil temperature at the discrete vertical levels below the soil surface. Soil temperature can be important in calculating the moisture decline rate. Each irrigation zone is further associated with an irrigation control unit comprising a controllable valve and a local controller. The controllable valve regulates the flow of water to the respective irrigation zone, while the local controller is operatively coupled to the soil moisture sensors and is configured to receive and process sensor data. The local controller may include a microprocessor, memory, and associated circuitry sufficient to perform data processing, storage, and control functions. In preferred embodiments, each control unit operates autonomously and does not require continuous cloud connectivity, although optional communication capabilities may be provided.

The local controller for each irrigation zone is configured to receive real-time sensor data, including soil moisture measurements and, in certain embodiments, environmental parameters such as ambient temperature, humidity, and weather-related data. Based on this data, the controller determines a current moisture condition within the root zone. In addition to real-time measurements, the controller utilizes one or more learned parameters representing moisture propagation characteristics and moisture decay behavior within the soil of the respective irrigation zone. These learned parameters may include, for example, rates of water infiltration, vertical percolation between sensor depths, and rates of moisture loss over time due to evaporation, plant uptake, or drainage.

In preferred implementations, the system undergoes an initial learning period during which the local controller collects sensor data over multiple irrigation cycles to derive the learned parameters. During this period, the controller evaluates the sufficiency and consistency of the collected data to establish reliable predictive models. Once sufficient data has been obtained, the learned parameters are stored locally and used to inform irrigation decisions. The system may continue to update these parameters over time to account for changes in soil composition, plant growth, seasonal variation, and other dynamic factors.

Using the current moisture condition and the learned parameters, the local controller generates a predicted moisture level at a target depth within the root zone. This prediction accounts not only for present conditions but also for expected moisture movement and dissipation over time. When the predicted moisture level falls below a predefined threshold associated with a desired moisture condition, the controller initiates an irrigation event by actuating the controllable valve associated with the irrigation zone. In some embodiments, irrigation may be initiated automatically, while in other embodiments the system may provide advance notification to a user and await user confirmation prior to initiating irrigation.

During an irrigation event, the controller continues to monitor updated soil moisture measurements from the sensors. Based on these measurements and the learned parameters, the controller determines a projected post-irrigation moisture level at the target depth. Importantly, the system is configured to terminate irrigation before the desired moisture condition is physically reached at the sensor location, based on a prediction that the continued propagation of water within the soil will result in achieving the desired condition after irrigation ceases. This predictive shutoff mechanism reduces overwatering and improves water use efficiency by accounting for delayed moisture movement within the soil profile.

Each irrigation zone operates independently, allowing irrigation timing, duration, and volume to be optimized based on zone-specific characteristics. This independence enables the system to accommodate variability across a field, including differences in soil type, slope, crop variety, and microclimate conditions. In some embodiments, multiple local controllers may communicate with one another via a wired or wireless network to coordinate irrigation activities, such as staggering irrigation events or batching zones with similar predicted water requirements.

The system may further incorporate resource optimization considerations into irrigation decisions. For example, irrigation timing may be adjusted based on water availability constraints, such as limited supply windows, or based on energy cost considerations when water delivery relies on electrically powered pumps. The system may also incorporate external data sources, including weather forecasts, to anticipate environmental conditions that affect soil moisture dynamics. These factors may be integrated into the predictive models or used as constraints in determining irrigation schedules.

In addition to real-time control, the system may store historical irrigation data, sensor measurements, and associated environmental data. This data may be correlated with crop yield and quality metrics to evaluate the effectiveness of different irrigation strategies. Over time, such analysis may be used to refine irrigation parameters and improve future performance. The accumulated data may also support broader agronomic analysis, enabling users to identify relationships between irrigation practices and crop outcomes across multiple growing cycles.

The irrigation control units may be powered by battery systems, optionally supplemented by renewable energy sources such as solar panels, allowing deployment in remote or infrastructure-limited environments. The modular and distributed nature of the system enables scalability from small installations to large agricultural fields comprising numerous independently controlled zones.

Overall, the invention provides a decentralized, adaptive irrigation control system that leverages real-time sensing, predictive modeling, and zone-specific control to deliver water with high precision at the root-zone level. By combining multi-depth moisture sensing, learned soil behavior, and predictive irrigation control, the system achieves improved water efficiency, reduced resource consumption, and enhanced crop performance compared to conventional irrigation approaches.

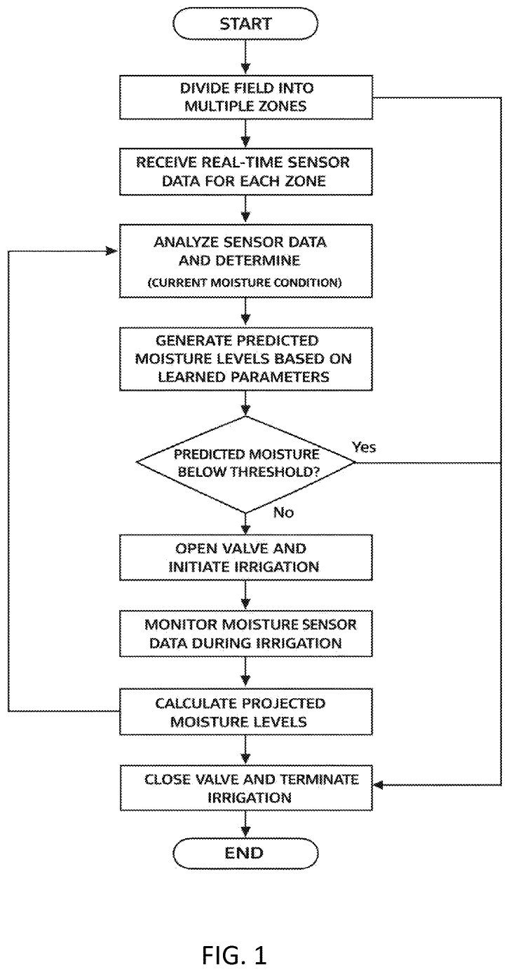

FIG. 1 is a flow chart that illustrates an exemplary operational sequence of the irrigation control method implemented by the present invention. The process begins with division of an agricultural field into a plurality of independently controlled irrigation zones. For each zone, real-time sensor data is received, including soil moisture measurements and, in certain embodiments, environmental parameters. This data is analyzed by a local controller to determine the current moisture condition within the root zone. Based on this analysis, the system generates predicted moisture levels at a target depth using previously learned parameters that characterize moisture propagation and decay behavior for the specific zone. A decision step then evaluates whether the predicted moisture level is below a predefined threshold corresponding to a desired moisture condition. If the threshold condition is not met, the system continues monitoring and analysis. If the threshold condition is met, the system initiates irrigation by opening a controllable valve associated with the zone. During irrigation, the system continuously monitors updated sensor data and calculates projected post-irrigation moisture levels. Based on this predictive analysis, the system determines when sufficient moisture will be achieved and terminates irrigation by closing the valve before the desired moisture level is physically reached, thereby accounting for ongoing moisture movement within the soil. The process then repeats, enabling continuous, adaptive, and zone-specific optimization of irrigation control.

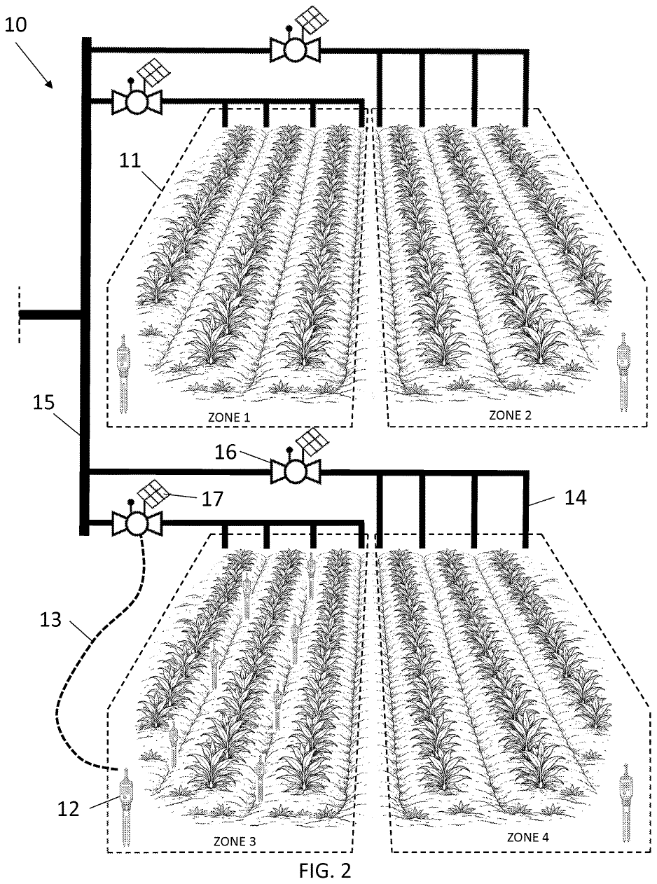

FIG. 2 illustrates an exemplary embodiment of the irrigation system 10 in which an agricultural field is divided into a plurality of independently controlled irrigation zones, specifically shown as Zone 1, Zone 2, Zone 3, and Zone 4, each defined by dashed boundary lines 11 and associated with a respective irrigation and sensing configuration. Each zone includes at least one vertically oriented soil moisture sensor 12 positioned within the ground and configured to measure moisture at multiple depths along the root zone. In certain embodiments, the sensor may include a plurality of sensing elements spaced along its length, for example at intervals ranging from approximately 2 to 10 centimeters, thereby enabling detailed profiling of moisture distribution from near-surface levels to deeper soil regions. The physical length of the sensor may vary depending on application requirements, including relatively short configurations of approximately twelve inches for shallow root systems, as well as extended configurations of up to approximately five feet or more to capture deep soil moisture conditions. The sensors may further incorporate additional sensing capabilities, including but not limited to temperature, pressure, or other environmental or soil-related variables. Each sensor may be powered by an internal battery and, in some embodiments, supplemented or maintained by an integrated solar panel to enable long-term autonomous operation in field conditions. Communication between the sensors and associated control components may be achieved through wireless transmission 13, such as radio frequency communication, or alternatively through wired connections 13.

Each irrigation zone further includes a water distribution manifold 14 connected to a fluid supply line 15, wherein the manifold distributes water to the crops within the defined zone. A controllable valve 16 is operatively coupled to each manifold, allowing independent regulation of water flow to each respective zone. The valves are configured to be motorized, thereby enabling remote actuation and automated control in response to sensor data and control algorithms. Similar to the sensors, the valves may be controlled via wireless communication or through hardwired connections 13, depending on system design and deployment constraints. The valves may also be powered by battery systems and/or optionally include solar panels 17 to provide sustainable energy for field operation. As depicted, the system architecture allows each zone to operate independently, such that irrigation delivery can be precisely controlled based on localized soil moisture conditions and other sensed parameters, thereby enabling zone-specific optimization of irrigation timing, duration, and volume across the agricultural field.

Referring back to FIG. 2, Zone 3 shows that a plurality of sensors may be installed in the ground. When the soil sensors can be first deployed within a field, the sensor can relay data back to the system. Even across a single field, the soil conditions can vary based on a variety of factors discussed herein. Thus, it can be first determined how best to install and segment the irrigation delivery into various zones based on the sensor feedback. This optimizes the use of the irrigation system where each zone can be configured to deliver the optimum watering schedules for a similarly responding zone of area.

The present invention can also handle water shortages better than other prior art systems. When the wells run dry, it is a tough decision by the farmer on where to use the remaining water supplies. With the present invention understanding exactly what the soil conditions and how they will change over time based on the needs of a particular crop, better decisions can be made during such tough times.

Although several embodiments have been described in detail for purposes of illustration, various modifications may be made to each without departing from the scope and spirit of the invention. Accordingly, the invention is not to be limited, except as by the appended claims.

What is claimed is:

1. A method for controlling irrigation of an agricultural field, the method comprising:
dividing the agricultural field into a plurality of irrigation zones;
providing, for each irrigation zone, at least one soil moisture sensor configured to measure moisture at a multitude of depths within a root zone of plants in the respective irrigation zone;
providing, for each irrigation zone, a corresponding irrigation control unit comprising a controllable valve and a local controller operatively coupled to the at least one soil moisture sensor;
receiving, at each local controller, real-time sensor data including at least soil moisture measurements and one or more environmental parameters;
determining, for each irrigation zone independently, a current moisture condition of the root zone based on the real-time sensor data;
generating, by the local controller for each irrigation zone, a predicted moisture level at a target depth based on (i) the current moisture condition and (ii) one or more learned parameters representing moisture propagation and decay characteristics of soil within the respective irrigation zone;
initiating an irrigation event for a selected irrigation zone by actuating the corresponding controllable valve when the predicted moisture level is below a predefined threshold;
monitoring, during the irrigation event, updated soil moisture measurements from the at least one soil moisture sensor;
determining, by the local controller, a projected post-irrigation moisture level at the target depth based on the updated soil moisture measurements and the learned parameters; and
terminating the irrigation event for the selected irrigation zone by closing the controllable valve when the projected post-irrigation moisture level is expected to satisfy a desired moisture condition;
wherein each irrigation zone is controlled independently wherein irrigation timing and volume are optimized on a per-zone basis according to zone-specific soil characteristics, environmental conditions, and learned moisture behavior.

2. The method of claim 1, wherein the at least one soil moisture sensor comprises a plurality of sensors positioned at different depths within the root zone, wherein the learned parameters include a rate of moisture propagation between the different depths.

3. The method of claim 1, wherein the learned parameters further include moisture decay rates following an irrigation event.

4. The method of claim 1, further comprising an initial learning period during which the local controller collects sensor data to derive the learned parameters, wherein the learning period includes evaluating sufficiency of collected data prior to using the learned parameters for irrigation control.

5. The method of claim 1, wherein the environmental parameters include at least one of ambient temperature, humidity, and/or weather forecast data.

6. The method of claim 1, wherein initiating the irrigation event further comprises automatically initiating irrigation without user intervention.

7. The method of claim 1, wherein terminating the irrigation event occurs prior to the target depth reaching the desired moisture condition based on the projected post-irrigation moisture level.

8. The method of claim 1, wherein each irrigation control unit operates independently without reliance on cloud-based processing.

9. The method of claim 1, wherein the local controllers communicate with one another in a network to coordinate irrigation across the plurality of irrigation zones.

10. The method of claim 1, further comprising adjusting irrigation timing based on availability of water supply and/or adjusting irrigation timing based on energy cost associated with operating irrigation equipment.

11. The method of claim 1, further comprising batching irrigation across multiple zones based on predicted future moisture requirements.

12. The method of claim 1, wherein the learned parameters are continuously updated over time to account for changes in soil composition or plant growth.

13. The method of claim 1, further comprising storing irrigation data and correlating the irrigation data with crop yield or quality metrics, and further comprising modifying irrigation strategies based on the correlation between irrigation data and crop yield or quality metrics.

14. An irrigation system for an agricultural field divided into a plurality of irrigation zones, the system comprising:
a plurality of soil moisture sensors, each associated with a respective irrigation zone and configured to measure soil moisture at a multitude of depths within a root zone;
a plurality of irrigation control units, each associated with a respective irrigation zone and comprising:
a controllable valve configured to regulate water delivery to the respective irrigation zone; and
a local controller operatively coupled to the soil moisture sensors;
wherein each local controller is configured to:
receive real-time sensor data including soil moisture measurements and environmental parameters;
determine a current moisture condition of the root zone for the respective irrigation zone;
generate a predicted moisture level at a target depth based on the current moisture condition and learned parameters representing moisture propagation and decay characteristics;
actuate the controllable valve to initiate irrigation when the predicted moisture level is below a predefined threshold;
monitor updated soil moisture measurements during irrigation; and
terminate irrigation based on a projected post-irrigation moisture level such that a desired moisture condition is achieved at the target depth;
wherein each irrigation control unit operates independently to optimize irrigation timing and volume for its respective irrigation zone.

15. The system of claim 14, wherein each irrigation control unit includes onboard data storage configured to store learned parameters.

16. The system of claim 14, wherein the soil moisture sensors are positioned at multiple depths within the root zone.

17. The system of claim 14, wherein each local controller includes a processor configured to execute a learning algorithm to derive the learned parameters.

18. The system of claim 14, wherein the irrigation control units are configured to operate without continuous network connectivity.

19. The system of claim 14, wherein the local controllers are configured to incorporate weather forecast data into irrigation decisions.

20. The system of claim 14, wherein the system is configured to aggregate irrigation and crop data to generate optimized irrigation strategies for future growing cycles.
